(19) United States
(12) Patent Application Publication
(10) Pub. No.: US 2006/0260640 A1
(43) Pub. Date: Nov. 23, 2006

(54) Method of manufacturing external panel of laundry treatment apparatus, and pattern formation apparatus and cleaning apparatus of the external panel

(76) Inventors: Ji Chang Son, Changwon-si (KR); Hyung Wook Chu, Changwon-si (KR); Woong Gil Cha, Changwon-si (KR); Kang Mo Choi, Masan-si (KR)

Correspondence Address: FLESHNER & KIM, LLP, P.O. BOX 221200, CHANTILLY, VA, 20153, US

(21) Appl. No.: 11/437,881

(22) Filed: May 22, 2006

(30) Foreign Application Priority Data
May 23, 2005 (KR) 10-2005-0043165

(51) Int. Cl. B08B 3/12; B08B 6/00

(52) U.S. Cl. 134/1

(57) ABSTRACT

The present invention relates to a method of manufacturing an external panel of a laundry treatment apparatus, and a pattern formation apparatus and cleaning apparatus of the external panel. According to an embodiment of the present invention, the method of manufacturing the external panel of the laundry treatment apparatus includes a panel formation step of forming an external appearance of the external panel, a pattern formation step of forming a predetermined pattern in the surface of the external panel, and a panel wash step of washing the external panel in which the pattern is formed by means of supersonic vibration. Accordingly, the external panel made of a metal material, which has a predetermined pattern formed on its surface, is mounted at the front of the door. It is therefore possible to improve the strength and beauty of the door. Furthermore, there is an advantage in that the corrosion and rust of the external panel, which are incurred by the oxidization effect of impurities, such as microchips, which are generated when the pattern is formed in the surface, can be prevented.

### BACKGROUND

1. Field of the Invention

The present invention relates to a panel of a laundry treatment apparatus. More particularly, the present invention relates to a method of manufacturing an external panel attached at the front of a doorframe of an apparatus for treating laundry, such as a washing machine or a drying machine, and a pattern formation apparatus and cleaning apparatus of the external panel.

2. Discussion of Related Art

In general, a laundry treatment apparatus is an apparatus for treating pollutants, a variety of foreign substance, etc., which are adhered on clothes, bedclothes, and so on (hereinafter, referred to as “laundry”) through processes such as washing, rinse, dehydration, dry, and the like. The laundry treatment apparatus may include a washing machine, a drying machine, and a combination dry and washing machine.

A laundry inlet port for inserting and drawing the laundry into and from the inside of the laundry treatment apparatus is formed at one side of the laundry treatment apparatus. A door for opening and shutting the laundry inlet port is pivotally disposed at one side of the laundry treatment apparatus.

FIG. 1 is a perspective view of a drum type washing machine 1 as an example of a laundry treatment apparatus in the related art. A circular door 2 for opening and shutting a laundry inlet port is pivotally installed at the front of the drum type washing machine 1.

The door 2 includes a doorframe 4 and a door glass 6.

The doorframe 4 is formed of a plastic material, which is light and easy to fabricate. The door glass 6 is formed of a glass material so that laundry input to the washing machine can be seen.

In recent years, in the laundry treatment apparatus, not only washing performance and durability, but also external design, use convenience, etc. are important factors to decide market quality. More particularly, there is a tendency that models are developed by paying careful attention to an operating mechanism, design, etc. of a washing machine when developing new products in order to meet consumers user convenience and beauty needs.

In the door 2 of the washing machine in the related art, however, the doorframe 4 is made of a plastic material, which degrades the strength and beauty of the door 2. Accordingly, a problem in that market quality of the washing machine is lowered.

Furthermore, although additional painting is coated on the external surface of the doorframe 4, there is a limit to adding fashionable texturing on the surface of the painting in terms of the beauty. There is also a problem in which the painting peels away after a long-term use.

To solve the problems, a metallic external panel is adhered on the surface of the doorframe 4 in order to create fashionable texturing in the doorframe 4 made of a plastic material and to strength the strength.

### SUMMARY OF THE INVENTION

The present invention has been developed in an effort to provide a method of manufacturing an external panel of a laundry treatment apparatus, in which a predetermined pattern of good texturing is formed on the surface of the external panel and the impurities remaining on the surface of the external panel, such as a variety of microchips, can be removed when forming a pattern in manufacturing the external panel of the laundry treatment apparatus.

Another object of the present invention is to provide a pattern formation apparatus of an external panel, in which a predetermined pattern can be formed on the surface of an external panel of a laundry treatment apparatus conveniently.

Further another object of the present invention is to provide a cleaning apparatus of an external panel, in which it can remove the impurities, such as microchips, which are created when a predetermined pattern is formed on the surface of the external panel.

According to an embodiment of the present invention, there is provided a method of manufacturing an external panel of a laundry treatment apparatus, including a panel formation step of forming an external appearance of the external panel, a pattern formation step of forming a predetermined pattern in the surface of the external panel, and a panel wash step of washing the external panel in which the pattern is formed by means of supersonic vibration.

In the panel formation step, the external panel is cut from a metal plate body made of a stainless steel material, wherein the external panel is ring-shaped in such a way to be mounted at the front of a door of the laundry treatment apparatus.

In the pattern formation step, the predetermined pattern is formed in the surface of the external panel by means of a grinding member. The pattern includes a plurality of hairlines.

Furthermore, the panel wash step includes a mounting process of mounting the external panel on a jig, and a wash process of containing the external panel mounted on the jig in wash liquid and then washing the external panel by means of supersonic vibration.

Furthermore, the panel wash step may include a cleaning process of cleaning the external panel using the air of a high pressure before the wash process, and a rinse process of rinsing the external panel using the wash liquid between the wash process and the dry process.

Furthermore, in the panel wash step, the wash process, the rinse process, and the dry process may be consecutively carried out in the same wash container, or the wash process, the rinse process, and the dry process may be performed in a wash container, a rinse container, and a dry container.

According to another embodiment of the present invention, there is provided an apparatus for forming a pattern of an external panel of a laundry treatment apparatus, including a worktable in which the external panel is fixed, a driving unit for rotating the worktable, a grinding unit for forming a predetermined pattern in the surface of the external panel, and a conveyer unit for conveying the grinding unit so that the grinding unit can be closely adhered to the external panel at a predetermined pressure.

Meanwhile, the worktable is pivotally disposed. In the grinding unit, a grinding member having a high surface intensity of illumination is mounted in a portion opposite to the external panel.

According to further another embodiment of the present invention, there is provided a cleaning apparatus of an external panel of a laundry treatment apparatus, including a jig on which the external panel of the laundry treatment apparatus is mounted, a wash container for containing the external panel mounted on the jig and storing wash liquid, a supersonic vibrator for supersonic vibrating the wash container, a dry container for containing the external panel washed in the wash container, and an air heating unit for drying the external panel contained in the dry container.

### BRIEF DESCRIPTION OF THE DRAWINGS

A more compete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a drum type washing machine as an example of a laundry treatment apparatus in the related art;

FIG. 2 is a perspective view of a drum type washing machine when the door is opened according to an embodiment of the present invention;

FIG. 3 is a perspective view of the drum type washing machine when the door is shut according to an embodiment of the present invention;

FIG. 4 is a cross-sectional view of the door of the drum type washing machine according to an embodiment of the present invention;

FIG. 5 is a flowchart illustrating a method of manufacturing an external panel according to a first embodiment of the present invention;

FIGS. 6a to 6c are cross-sectional views of the external panel, which are shown according the manufacturing steps according to a first embodiment of the present invention;

FIG. 7 is a view illustrating the construction of a pattern formation apparatus of an external panel according to an embodiment of the present invention;

FIG. 8 is a view illustrating the construction of a cleaning apparatus of the external panel according to an embodiment of the present invention;

FIG. 9 is a plan view of the cleaning apparatus shown in FIG. 8; and

FIG. 10 is a block diagram illustrating a method of manufacturing an external panel according to a second embodiment of the present invention.

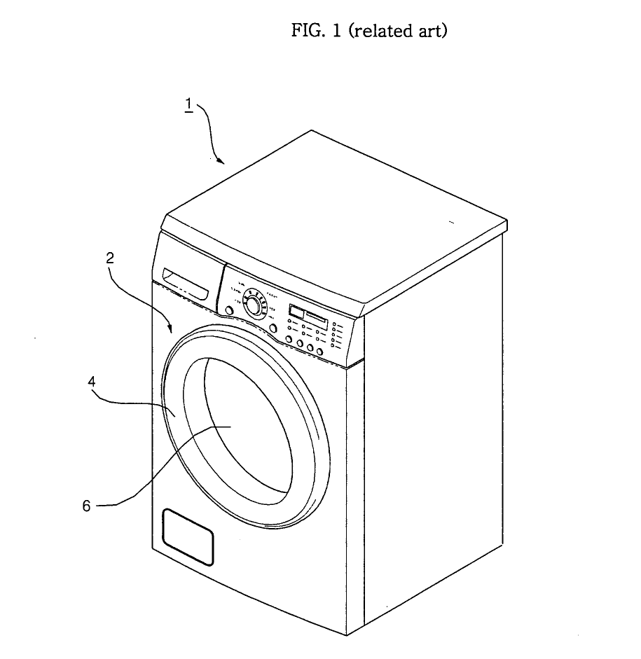

### DETAILED DESCRIPTION OF THE INVENTION

In the following detailed description, only certain exemplary embodiments of the present invention have been shown and described simply by way of illustration.

Hereinafter, a method of manufacturing an external panel of a laundry treatment apparatus, and a pattern formation apparatus and cleaning apparatus of the external panel according to an embodiment of the present invention will be described in connection with specific embodiments.

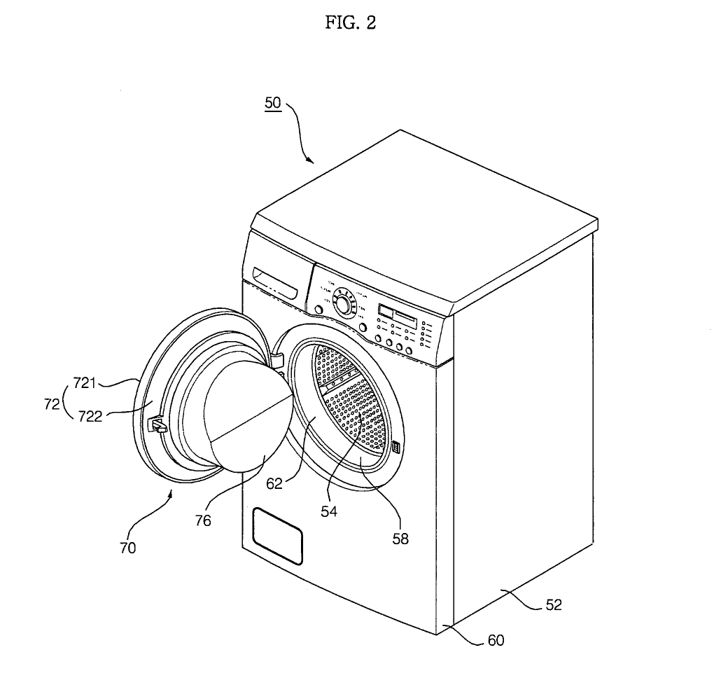

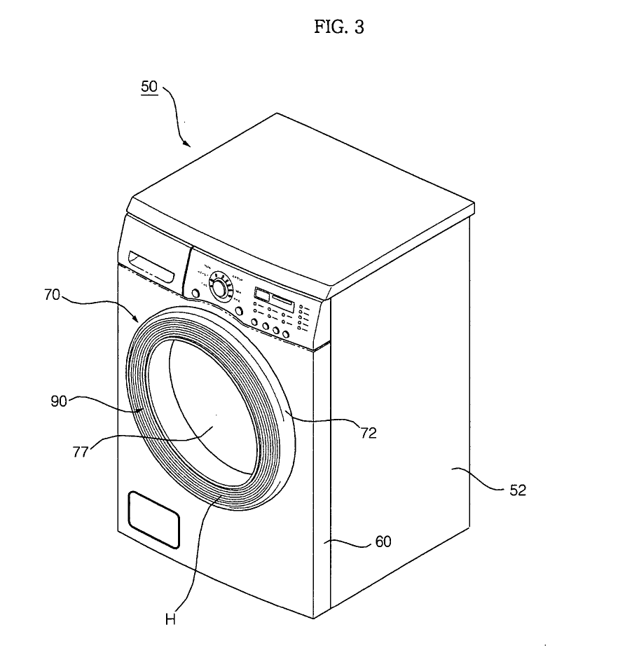

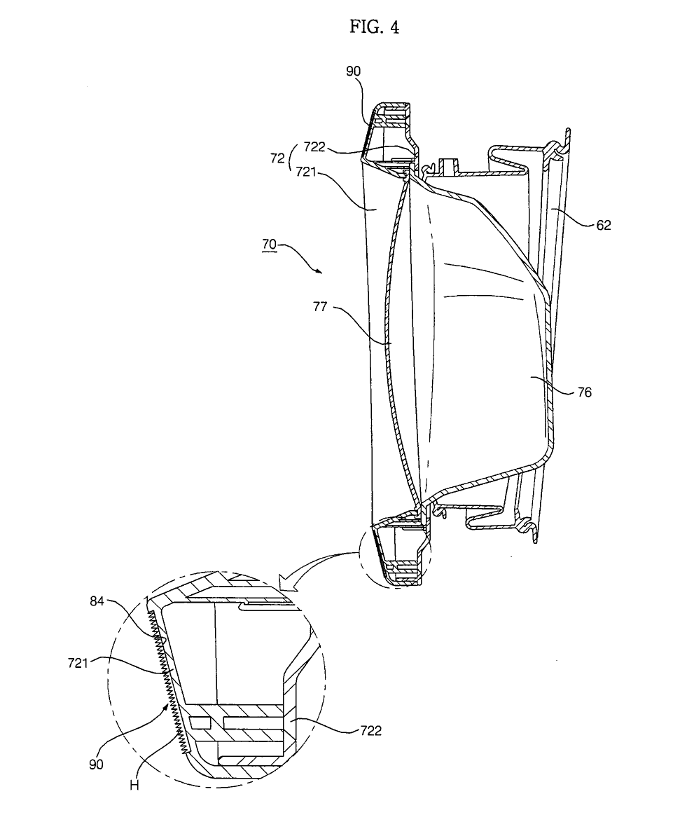

FIG. 2 is a perspective view of a drum type washing machine when the door is opened according to an embodiment of the present invention. FIG. 3 is a perspective view of the drum type washing machine when the door is shut according to an embodiment of the present invention. FIG. 4 is a cross-sectional view of the door of the drum type washing machine according to an embodiment of the present invention.

The drum type washing machine of the laundry treatment apparatus according to an embodiment of the present invention includes a cabinet 52 forming an external appearance, a drum 54 disposed within the cabinet 52, for containing laundry, a cabinet cover 60 disposed at the front of the cabinet 52, and a door 70 pivotally disposed in the cabinet cover 60, for opening and shutting the laundry inlet port 58, as shown in FIGS. 2 and 3. A laundry inlet port 58 through which the laundry can pass is formed therein in the cabinet cover 60.

The door 70 includes a ring-shaped doorframe 72, a door glass 76 projected toward the drum at the center of the doorframe 72, and an external panel 90 mounted on an external surface of the doorframe 72.

In this case, the ring-shaped doorframe 72 includes a front doorframe 721 forming the front part of the door 70, and a rear doorframe 722 that is mounted at the rear of the front doorframe 721 and forms the rear part of the door 70.

The front doorframe 721 and the rear doorframe 722 are formed of a plastic material, which is light and has a good machining property, through ejection.

Furthermore, the outer corner of the door glass 76 is inserted into the inner corners of the front doorframe 721 and the rear doorframe 722 so that the opened center of the doorframe 72 can be shut.

The door glass 76 allows a user to see the inside of the drum 54 when the drum type washing machine is driven. When the door 70 is shut, the door glass 76 is closely adhered to a gasket 62, thus preventing wash water contained within the drum 54 from leaking outside.

A safety cover 77 is disposed at the front side of the door glass 76. The safety cover 77 serves to protect the door glass 76 from external shock and also to prevent a user from being burnt by the door glass 76 that is heated at high temperature during dry and boiling washing.

Meanwhile, the external panel 90 is made of a metal material. Hair lines H are formed in the surface of the panel 90. The panel is inserted into a panel insert groove 84 formed at the front side of the front doorframe 721.

The panel insert groove 84 is formed to be circular at the front of the front doorframe 721 along the cylindrical direction and is depressed in a depth, which is deeper than or the same as that of the external panel 90.

The external panel 90 is fixed to the panel insert groove 84 in various manners. For example, the external panel 90 may be fixed to the panel insert groove 84 through compression, such as a press-fit method, using adhesives such as a both-sided tape, or using an additional fastening structure.

The external panel 90 is made of a stainless steel material having a good corrosion-proof property. A predetermined pattern is formed at the front of the external panel 90 in order to give a feeling of luxury. The pattern may have a plurality of looped hairlines H.

The hairlines H are very thin lines of the front of the external panel 90 which are grinded by a grinding member 105 to be described later. The plurality of hairlines H are formed with different radii at the front of the external panel 90.

Accordingly, the front of the external panel 90 has a cross section in which mountains and valley are continuous due to the plurality of hairlines H.

Meanwhile, the strength of the doorframe 72 is reinforced by the external panel 90 of the metal material, and the door 70 has luxury glazing and texturing by means of the ring-shaped hairlines H.

A manufacturing method of the external panel of the laundry treatment apparatus according to a first embodiment of the present invention will be described in detail below.

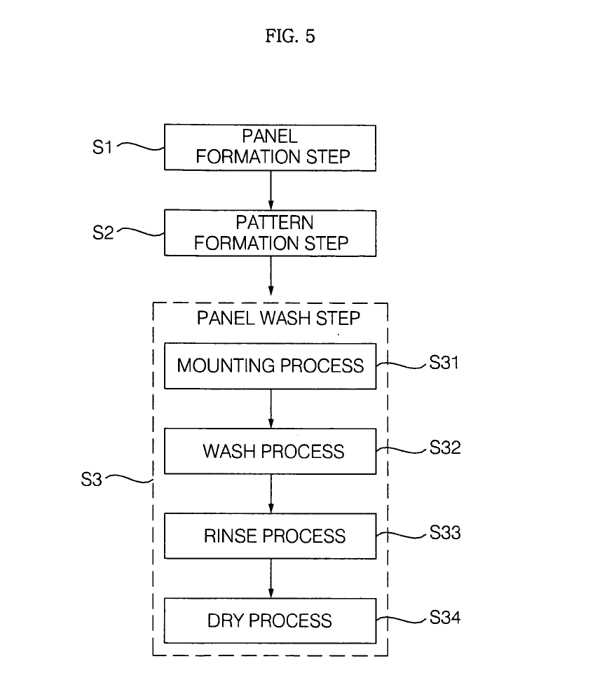

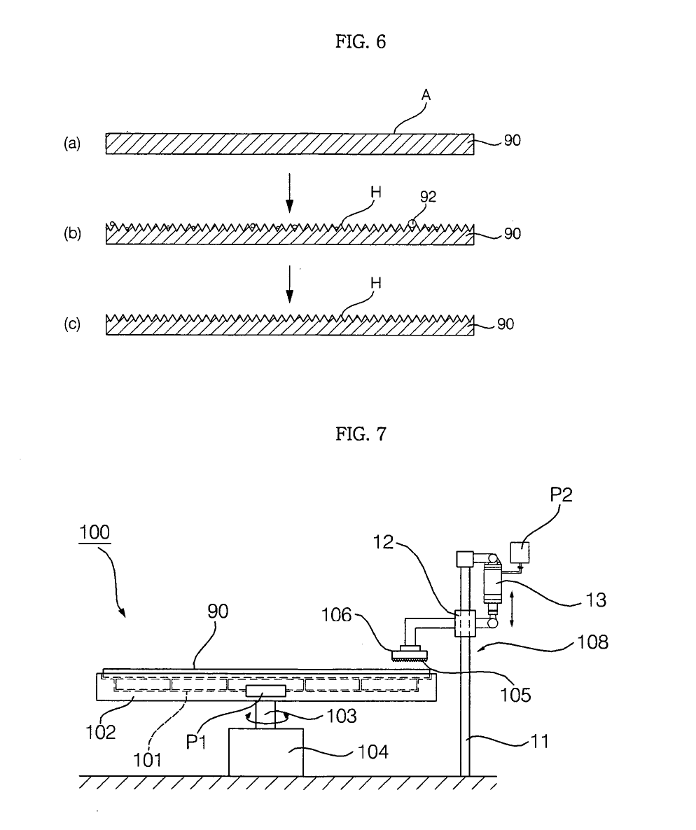

FIG. 5 is a flowchart illustrating a method of manufacturing an external panel according to a first embodiment of the present invention. FIGS. 6a to 6c are cross-sectional views of the external panel, which are shown according the manufacturing steps according to a first embodiment of the present invention.

A ring-shaped external appearance of the external panel 90 is first formed using a wide plate of a stainless steel material (S1).

The external panel 90 may be directly cut from the stainless steel plate in a ring shape or may be formed in a ring shape by combining a plurality of slices, which has been cut.

A surface A of the external panel 90 is flat.

If the external panel 90 is cut from the stainless steel plate, the ring-shaped hairlines H are formed at the surface A of the external panel 90 by means of the pattern formation apparatus 100 (S2).

Meanwhile, FIG. 7 illustrates an exemplary construction of the pattern formation apparatus 100 for forming the hairlines H in the surface of the external panel 90.

The pattern formation apparatus 100 includes a worktable 102 on which the external panel 90 is fixed, a driving unit 104 that drives the worktable 102, a grinding unit 106 having a grinding member 105 for grinding a predetermined pattern in the surface of the external panel 90, and a conveyer unit 108f for moving the grinding unit 106 in up and down directions so that the grinding unit 106 can be closely adhered or detached to or from the surface of the external panel 90.

The worktable 102 includes adsorption means on which the external panel 90 is placed. A rotary shaft 103 connected to the driving unit 104 is formed at the center of the worktable 102.

The adsorption means includes a vacuum pump P1 and an air adsorption path 101. If the vacuum pump P1 is driven, air on the surface of the worktable 102 is adsorbed through the air adsorption path 101, so that the external panel 90 is adsorbed to the worktable.

The grinding member 105 is made of a grinding material with a rough roughness, such as sandpaper or scrubber. The grinding member 105 is disposed over the surface of the external panel 90 and is brought in contact with the surface of the external panel 90 while being fallen by the conveyer unit 108.

The conveyer unit 108 includes a rod 11 being upright in up and down directions, a moving object 12 that is inserted into the rod 11 in such a way to be moved up and down and is connected to the grinding unit 106, a cylinder 13 for moving the moving object 12 up and down, and a hydraulic pump P2 connected to the cylinder 13. If the hydraulic pump P2 is driven, the piston of the cylinder 13 is moved forward and backward so that the moving object 12 is conveyed in up and down directions.

A surface machining method of the panel 90 using the pattern formation apparatus 100 constructed above will be described below.

The external panel 90 is fixed on the top surface of the worktable 102 so that a surface A in which the hairlines H will be formed is oriented upwardly. In this state, if the worktable 102 is rotated at a constant speed by means of the driving unit 104, the grinding member 105 of the grinding unit 106 is closely adhered to the surface A of the external panel 90 that is rotated along with the worktable 102 at a predetermined pressure by means of the hydraulic pump P2 and the cylinder 13, so that the ring-shaped hairlines H are formed at the surface A of the external panel 90.

Therefore, the thickness, shape, etc., of the hairlines H can be controlled depending on the type, adhesion pressure, etc. of the grinding member 105.

If the surface of the external panel 90 is machined by the grinding member 105 of the grinding unit 106, mountains and valleys are formed in the surface A of the external panel 90 in a cylindrical shape due to the plurality of hairlines H. Accordingly, impurities 92, such as a variety of microchips, which are generated when grinding the external panel 90, are filled and are laid up between the valleys of the hairlines H.

If the external panel 90 is mounted in the door 70 in a state where a variety of the impurities 92 exist in the hairlines H of the external panel 90 as described above, the impurities 92 are oxidized through the reaction with moisture or wash water. Accordingly, rust occurs on the surface of the external panel 90 and the external panel 90 is corroded. This can damage the external panel 90 and degrade the beauty of the door 70. Therefore, rust of the external panel 90 is adhered to the laundry.

To solve the problems, the external panel 90 in which the hairlines H are machined is washed in order to remove the impurities 92 existing in the hairlines H using the ultrasonic washing device 110 before being inserted into the panel insert groove 84 of the doorframe 72 (S3).

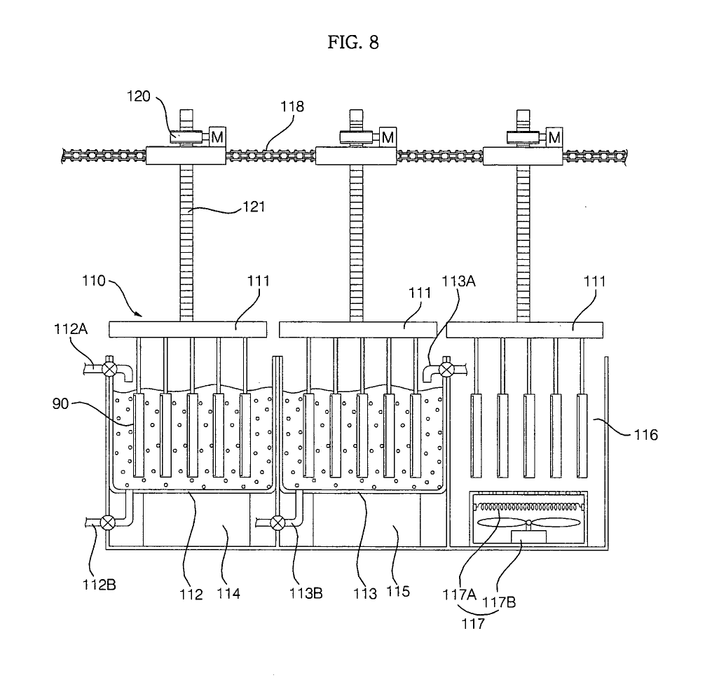

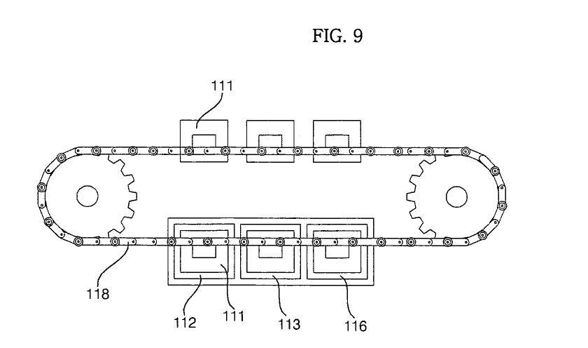

FIGS. 8 and 9 illustrate the ultrasonic washing device 110 according to an embodiment of the present invention.

The ultrasonic washing device 110 includes a jig 111 in which the plurality of external panels 90 are mounted, a wash container 112 including a feed path 112A and a drain path 112B of wash liquid, for containing the external panel 90 in which the jig 111 is mounted, a rinse container 113 that is located next to the wash container 112 and has a feed path 113A and a drain path 113B for feeding or draining wash liquid, supersonic generators 114 and 115 disposed under the wash container 112 and the rinse container 113, respectively, so that supersonic waves can be transmitted to the wash liquid stored in the wash container 112 and the rinse container 113, a dry container 116 formed next to the rinse container 113, and an air heating unit 117 disposed at one side of the dry container 116, for drying the external panel 90. The jig can be moved in a vertical direction by a rotation body 120 and a screw rod 121, which are rotated by a motor M, and can also be moved in a horizontal direction by a chain belt 118.

The plurality of external panels 90 are mounted in the jig 111 at a predetermined distance in left and right directions. The jig 111 and the external panel 90 are sequentially contained in the wash container 112, the rinse container 113, and dry container 116 while being moved in vertical and horizontal directions.

The air heating unit 117 is disposed under the dry container 116, and it includes a heater 117A for heating surrounding air, and a ventilator 117B for sending air heated by the heater 117A to the external panel. Accordingly, the external panel 90 contained within the dry container 116 can be dried.

Water may be used as the wash liquid in order to facilitate handling convenience and to save the cost.

A cleaning method of the external panel 90 using the ultrasonic washing device 110 constructed above will be described below.

The plurality of external panels 90 are mounted in the jig 111 so that they are spaced apart in front, rear, left, and right directions (S31)

The jig 111 falls as the motor M is driven so that the external panel 90 is completely immersed in the wash liquid of the wash container 112.

At this time, as the supersonic generator 114 installed at the wash container 112, the surface of the external panel 90 is washed by the wash liquid (S32).

After the external panel 90 is washed, the impurities 92 existing between the hairlines H formed in the surface B of the external panel 90, such as a variety of microchips, are completed separated from the surface of the external panel 90.

Thereafter, the motor M is driven to raise the jig 111. The chain belt 118 is then driven so that the jig 111 is placed on the rinse container 113. The motor M is driven to fall the jig 111 so that the external panel 90 mounted in the jig 111 is completely immersed in the wash liquid of the rinse container 113. If the supersonic generator 115 is driven, the surface of the external panel 90 is rinsed by the wash liquid (S33).

Unlike the above, the external panel 90 can be washed and rinsed in such a manner that the jig 111 is vibrated or fluctuated within the wash container 112 and the rinse container 113 in a state where the supersonic generator 115 is not installed in the wash container 112 and the rinse container 113 of the supersonic washing device 110.

If the external panel 90 is rinsed as described above, the motor M and the chain belt 118 are driven to move the jig 111 from the rinse container 113 to the dry container 116. The air heating unit 117 installed at the dry container 116 is driven to dry the external panel 90 through heated air (S34). The ultrasonic washing device of the external panel may include only the wash container and the dry container or may include only the wash container.

In the case where the ultrasonic washing device is one wash container, washing, rinse, and dry can be consecutively performed in a state where the plurality of external panels 90 is contained within the wash container. Accordingly, the ultrasonic washing device can be made compact compared with an ultrasonic washing device having a plurality of containers and is advantageous in that a variety of processes can be performed in batches at the same place.

The dried external panel 90 is input to the production line of the drum type washing machine 50 and is inserted into the panel insert groove 84 of the front doorframe 721 so that the machined surface of the hairlines H is oriented forwardly. The front doorframe 721 is coupled with the front of the rear doorframe 722, thereby completing the fabrication of the door 70.

Therefore, the external panel 90 can be mounted in the door 70 in a state where the impurities 92 of the hairlines H, such as a variety of microchips, are completely removed. Accordingly, the corrosion of the surface and the occurrence of rust, which are incurred by the oxidization effect of the impurities 92, can be prevented. Furthermore, since the strength of the doorframe 72 is reinforced by the external panel 90 of the stainless steel material, the deformation of the doorframe 72 can be prevented.

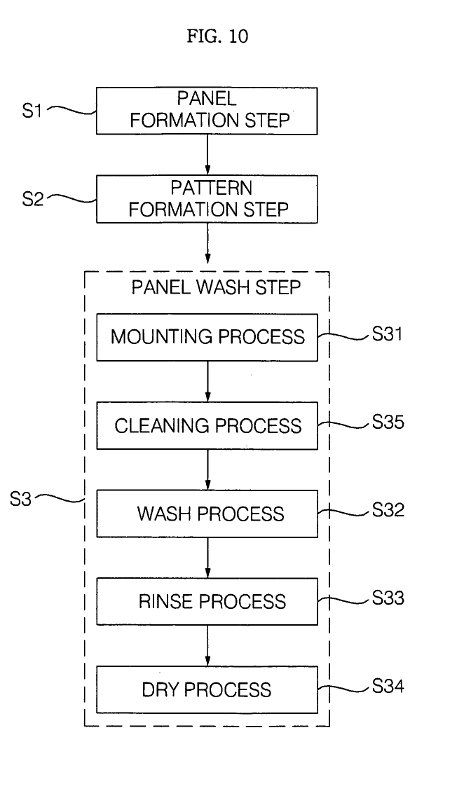

FIG. 10 is a block diagram illustrating a method of manufacturing an external panel according to a second embodiment of the present invention.

The same reference numbers will be used to refer to the same parts as those of the first embodiment and description thereof will be omitted.

A method of manufacturing an external panel of a laundry treatment apparatus according to a second embodiment of the present invention includes a cleaning process of cleaning the surface of the external panel 90 using the air of a high pressure either before or after the external panel 90 is mounted in the jig 111 when the external panel 90 is washed (S35). The remaining process steps are the same as those of the first embodiment.

In other words, before the external panel 90 is washed in the wash container 112 of the ultrasonic washing device 110, the air of a high pressure is sprayed on the surface in which the hairlines H of the external panel 90 are formed in order to primarily remove the impurities 92 filled or inserted into the valleys of the hairlines H, such as a variety of microchips.

Accordingly, the cleaning performance and the rinse performance of the external panel 90, which are performed after the cleaning process, can be secured sufficiently. As a result, the washing time and the rinse time of the external panel 721 can be shortened.

As described above, although the method of manufacturing the external panel of the laundry treatment apparatus, and the pattern formation apparatus of the external panel have been described with reference to the illustrated drawings, it is to be understood that the invention is not limited to the disclosed embodiments, but, on the contrary, is intended to cover various modifications and equivalent arrangements included within the spirit and scope of the appended claims.

In other words, the door of the laundry treatment apparatus may have a variety of shapes other than the circle. Accordingly, the external panel can be formed in various shapes other than the ring shape and can be mounted on the external surface of the door.

Furthermore, the external panel may also be mounted in other places of the laundry treatment apparatus other than the external surface of the door.

As described above, in accordance with the manufacturing method of the external panel of the laundry treatment apparatus according to the present invention, the external panel made of a metal material, which has a predetermined pattern formed on its surface, is mounted at the front of the door. It is therefore possible to improve the strength and beauty of the door.

Furthermore, the external panel is formed of a stainless steel material, and impurities generated when a pattern is formed in the surface, such as a variety of microchips, can be completely removed through supersonic washing. Accordingly, there is an advantage in that the corrosion and rust of the external panel, which are incurred by the oxidization effect of the impurities, can be prevented.

In addition, a plurality of hairlines (i.e., a concentric circle) are grinded in the external panel of the stainless steel material. Accordingly, there is an advantage in that the laundry treatment apparatus has a beautiful glazing and surface texturing by means of the external panel.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing an external panel of a laundry treatment apparatus, the method comprising:
a panel formation step of forming an external appearance of the external panel;
a pattern formation step of forming a predetermined pattern in the surface of the external panel; and
a panel wash step of washing the external panel in which the pattern is formed by means of supersonic vibration.

2. The method as claimed in claim 1, wherein in the panel formation step, the external panel is cut from a metal plate body made of a stainless steel material.

3. The method as claimed in claim 1, wherein in the panel formation step, the external panel is ring-shaped in such a way to be mounted at the front of a door of the laundry treatment apparatus.

4. The method as claimed in claim 1, wherein in the pattern formation step, the predetermined pattern is formed in the surface of the external panel by means of a grinding member.

5. The method as claimed in claim 1, wherein in the pattern formation step, a plurality of hairlines are formed in the surface of the external panel.

6. The method as claimed in claim 5, wherein the external panel is formed to be ring-shaped, and the hairlines have a plurality of looped hairlines (i.e., a concentric circle).

7. The method as claimed in claim 1, wherein the panel wash step comprises a mounting process of mounting the external panel on a jig, and a wash process of containing the external panel mounted on the jig in wash liquid and then washing the external panel by means of supersonic vibration.

8. The method as claimed in claim 7, further comprising a dry process of drying the external panel.

9. The method as claimed in claim 7, wherein the panel wash step comprises a cleaning process of cleaning the external panel using the air of a high pressure before the wash process.

10. The method as claimed in claim 9, wherein the panel wash step further comprises a rinse process of rinsing the external panel using the wash liquid between the wash process and the dry process.

11. The method as claimed in claim 10, wherein the rinse process includes immersing the external panel in the wash liquid and then rising the external panel by means of supersonic vibration.

12. The method as claimed in claim 10, wherein the rinse process includes immersing the external panel in the wash liquid and then rising the external panel by means of the vibration of the jig.

13. The method as claimed in claim 10, wherein in the panel wash step, the wash process, the rinse process, and the dry process are consecutively carried out in the same wash container.

14. The method as claimed in claim 9, wherein in the panel wash step, the wash process, the rinse process, and the dry process are performed in a wash container, a rinse container, and a dry container.

15. An apparatus for forming a pattern of an external panel of a laundry treatment apparatus, the apparatus comprising:
a worktable in which the external panel is fixed;
a driving unit for rotating the worktable;
a grinding unit for forming a predetermined pattern in the surface of the external panel; and
a conveyer unit for conveying the grinding unit so that the grinding unit can be closely adhered to the external panel at a predetermined pressure.

16. The apparatus as claimed in claim 15, wherein the worktable includes adsorption means for adsorbing and fixing the external panel.

17. The apparatus as claimed in claim 15, wherein the conveyer unit comprises a rod, a moving object installed in the rod movably in up and down directions and connected to the grinding unit, and a hydraulic cylinder for moving the moving object in up and down directions.

18. A cleaning apparatus of an external panel of a laundry treatment apparatus, the cleaning apparatus comprising:
a jig on which the external panel of the laundry treatment apparatus is mounted;
a wash container for containing the external panel mounted on the jig and storing wash liquid;
a supersonic vibrator for supersonic vibrating the wash container;
a dry container for containing the external panel washed in the wash container; and
an air heating unit for drying the external panel contained in the dry container.

19. The cleaning apparatus as claimed in claim 18, further comprising an up and down moving unit for moving the jig up and down, and a horizontal moving unit for moving the jig horizontally.

20. The cleaning apparatus as claimed in claim 18, further comprising a rinse container for rinsing the external panel washed in the wash container between the wash container and the dry container.
